(19) United States
(12) Patent Application Publication
(10) Pub. No.: US 2024/0426107 A1
(43) Pub. Date: Dec. 26, 2024

(54) Screening arrangement with a top casing and a bottom element comprising a screening body receiving space

(71) Applicant: VKR Holding A/S, Hørsholm (DK)

(72) Inventors: Martin Birkkjær BOYSEN, Esbjerg (DK); Lone Ejbæk MEYER, Tarm (DK); Jan THOMSEN, Ringkøbing (DK)

(21) Appl. No.: 18/544,181

(22) Filed: Dec. 18, 2023

(30) Foreign Application Priority Data
Jun. 20, 2023 (DK) PA 2023 70317

(51) Int. Cl. E04D 13/03; E06B 9/92

(52) U.S. Cl. CPC E04D 13/033; E06B 9/92

(57) ABSTRACT

In the screening arrangement (10), the screening body (15) is rolled-up, folded-up or collapsed in a non-screening position in a combined space of a top casing (11) and a receiving space (RS) in the bottom element (14). The top casing (11) comprises a front rail (114), a top cover portion (113), and a back cover portion (115). The bottom element (14) is connected to the bottom portion (154) of the screening body (15) and comprises a front (140), an upwards facing surface (145), and a back portion (149). The back portion (149) is configured to accommodate one or more solar panels (27) on an exterior side, facing the exterior in a mounted condition of the screening arrangement (10). The top edge (149a) of the back portion (149) of the bottom element (14) is located at a higher level than the upwards facing surface (145), and the receiving space (RS) is delimited in the longitudinal direction (L) by a first plane (P1) substantially parallel with a plane spanned by the width direction (W) and the depth direction (D), and a second plane (P2) parallel with the first plane (P1) and located at a higher level than the first plane (P1). The first plane (P1) is defined by a lowest point on the upwards facing surface (145), and the second plane (P2) is defined by a top edge (140a) of the front (140) or a top edge (149a) of the back portion (149) of the bottom element (14), whichever is located at the highest level as seen in the longitudinal direction (L), and at least the top portion (151) of the screening body is located to the exterior of and above a bottom edge (114b) of the front rail (114) of the top casing (11) such that a majority of the rolled-up, folded-up or collapsed screening body (15) is accommodated in said receiving space (RS) and the top casing (11) in the non-screening position.

### TECHNICAL FIELD

The present invention relates to a screening arrangement for a window, preferably a roof window, said window comprising a frame with a top member, a bottom member and two mutually parallel side members, said screening arrangement comprising a screening body having two side edges and a top and bottom portion and configured to assume rolled-up, folded-up or collapsed condition in a non-screening position, a top casing accommodating at least the top portion of the screening body, said top casing comprising a front rail, a top cover portion, and a back cover portion, the front rail defining a first direction corresponding to a width direction of the screening arrangement, the first direction being perpendicular to a second direction corresponding to a longitudinal direction, the first and second direction being perpendicular to a third direction corresponding to a depth direction, a bottom element connected to the bottom portion of the screening body and being configured to be longitudinally positionable in said longitudinal direction by means of electric drive means, between the non-screening position of the screening body and a screening position, in which the screening body has been deployed, the bottom element comprising a front, an upwards facing surface, and a back portion, the back portion being configured to accommodate one or more solar panels on an exterior side, facing the exterior in a mounted condition of the screening arrangement.

### BACKGROUND ART

Screening arrangements of this kind are known in the art and from commercially available products such as VELUX® DSL and RSL. Electrically operated screening arrangements powered by solar panels facing the exterior in the mounted condition have numerous advantages compared to screening arrangement powered by the mains power of the building in which the window to be screened is installed, including easy retrofitting and sustainably sourced energy. Examples of prior art screening arrangements with solar panels on the exterior side of the bottom element include KR 101811684 B1, US 2019/0277086 A1, and WO 02/41740 A1.

In general, it is a desire that such solar panels take up as little space as possible, in particular in the non-screening position, so as to not impede the view. When screening windows installed in a façade of a building, there is generally more freedom in designing the components of the screening device including such solar panels, but in interior screening arrangements designated for use in roof windows, the location of the screening arrangement close to the windowpane, and in an inclined position, poses particular challenges due to the limited available space. Needless to say, the desire to minimise the size of the solar panels is in conflict with the need for collecting sufficient energy to power the screening device of the screening arrangement, possibly also by accumulating the collected energy in suitable storages such as batteries.

### SUMMARY OF INVENTION

With this background, it is therefore an object of the invention to provide a screening arrangement which is compact and which at the same time provides adequate room for the solar panel or panels.

This and further objects are met by a screening arrangement of the kind mentioned in the introduction, which is furthermore characterised in that the top edge of the back portion of the bottom element is located at a higher level than the upwards facing surface, that the bottom element comprises a receiving space for receiving a part of the rolled-up, folded-up or collapsed screening body in the non-screening position, said receiving space being delimited in the longitudinal direction by a first plane substantially parallel with a plane spanned by the width direction and the depth direction, and a second plane parallel with the first plane and located at a higher level than the first plane, that the first plane is defined by a lowest point on the upwards facing surface, and the second plane is defined by a top edge of the front or a top edge of the back portion of the bottom element, whichever is located at the highest level as seen in the longitudinal direction, and that at least the top portion of the screening body is located to the exterior of and above a bottom edge of the front rail of the top casing such that a majority of the rolled-up, folded-up or collapsed screening body is accommodated in said receiving space and the top casing in the non-screening position.

In this way, the bottom element contributes to the available space for storing the screening body in the non-screening position, thus contributing to the compactness of the screening arrangement. The screening body is thus accommodated in a combined space comprising the volume dedicated to the screening body within the top casing and the receiving space within the bottom element. The configuration of the inventive screening arrangement contributes to solving the inherent conflict between the need for the screening body to cover the entire window opening in the fully screening position on the one hand, while it on the other hand is desirable that as much as possible of the screening body is hidden from view and the entire screening arrangement takes up as little space as possible in the longitudinal direction in the non-screening position. Since the top edge of the back portion of the bottom element is located at a higher level than the upwards facing surface, it is at all times ensured that a sufficient area for the solar panel or panels is available on the back side of the bottom element.

By providing the upper section of the bottom element with an L- or U-shaped configuration, it is possible to configure the top casing and the volume dedicated to accommodating the screening body within the top casing accordingly in order to ensure an optimum fit between the bottom element and the top casing in the non-screening position.

In one presently preferred embodiment, the top edge of the front of the bottom element is located at a higher level than the top edge of the back portion. In this way, a U-shaped configuration is formed at the upper section of the bottom element in which the front of the bottom element is rendered the tallest component of the bottom element which in turn has the advantage that the front may contribute to protecting and hiding from view the lower part of the rolled-up, folded-up or collapsed screening body as seen from the interior of the building in the non-screening position. A further advantage is that there is more flexibility in forming the back portion of the bottom element and the back cover portion of the top casing. This configuration provides the possibility of optimising the combined space available for accommodating the screening body in that the contribution from the bottom element by its receiving space may be made quite substantial and even larger than the contribution from the dedicated volume within the top casing.

In another embodiment, the top edge of the front of the bottom element is located at a lower level than the top edge of the back portion. This provides the possibility of providing the upper section of the bottom element as either a U-shaped or an L-shaped configuration, by which it is possible to form the back portion as the tallest component and hence maximise the available height in the longitudinal direction for the solar panel or panels.

In a further development of this embodiment, the top edge of the front of the bottom element is located at substantially the same level as the upwards facing surface, that is, an L-shaped configuration of the upper section is achieved, by which the height of the solar panel(s) may be optimised without special requirements to the front of the bottom element.

In one presently preferred embodiment, the top edge of the front of the bottom element is located at substantially the same level as the bottom edge of the front rail of the top casing in the non-screening position. This provides for a good protection of the screening body from dust and other airborne impurities in the interior of the building that could otherwise settle on the screening body, in addition to the visually pleasing appearance of the screening arrangement in the non-screening position.

In another presently preferred embodiment, the top edge of the back portion of the bottom element is located at substantially the same level as a bottom edge of the back cover portion of the top casing in the non-screening position. In this way, a barrier towards the exterior is formed such that the screening body is protected from incident light, thus mitigating the detrimental effects of UV exposure on the material of the screening body.

In principle, the bottom element may be manufactured in any suitable manner. In one presently preferred embodiment, the bottom element comprises a main portion composed by a set of profiles defining a cross-sectional shape of the bottom element, and two end portions located at respective longitudinal ends of the main portion of the bottom element. The use of profiles, which may for instance be formed by extrusion, makes it possible to standardise the production to a considerable extent and facilitates assembly of the screening arrangement. For instance, one and the same profile may be used for forming the front of the bottom element, while different profiles may be used on the exterior side of the front to take varying configurations depending on the type of screening device including type of screening body. In turn, this makes it possible to obtain a harmonised appearance towards the interior for an entire product line of screening arrangements.

In one development of this preferred embodiment, a first profile comprises the front of the bottom element and a second profile comprises the back portion and the upwards facing surface of the bottom element, a third profile being preferably provided for fastening the bottom portion of the screening body. This configuration is particularly well-suited for screening devices comprising a roller blind which typically require fastening of the bottom portion of the screening body connected close to the top edge of the front.

In another development of this preferred embodiment, a first profile comprises the front of the bottom element and a second profile comprises the back portion, and a third profile comprises the upwards facing surface of the bottom element and is provided with means for fastening the bottom portion of the screening body. This configuration is particularly advantageous in screening devices having a screening body which is folded or collapsed in the non-screening position and in which the bottom portion of the screening body is typically fastened centrally in the bottom element as seen in the depth direction. This applies for instance to pleated blinds and cellular blinds.

Regardless of the type of screening body, a particular advantage in forming the bottom element by a set of profiles is achieved in an embodiment in which the first profile has a length exceeding the length of the second profile such that a space is provided at each longitudinal end of the main portion to accommodate parts of the end portions to the exterior of the front comprised in the first profile, as seen in the depth direction. In this way, the exterior end portions are hidden from view and protected from the interior of the building.

The configuration of the solar panel or panels is in principle arbitrary and the solar panel(s) may have any suitable dimensions, i.e. height in the longitudinal direction, length in the width direction, and thickness in the depth direction, but in one embodiment, each at least one solar panel has a height substantially corresponding to the height of the exterior side of the back portion of the bottom element. Thus, the usage of the available area is optimised.

The requirements to the power supply from the solar panel(s) depends to some extent on the size of the screening device of the screening arrangement, that is, the dimensioning of the available capacity is dependent on the size of roof window in which the screening arrangement is to be installed. Hence, screening arrangements intended for small-sized roof windows may be provided with a single solar panel, while larger versions will require two or more solar panels. In order to improve the modularity of the components for a given size range during manufacture, one presently preferred embodiment provides for the exterior side of the back portion of the bottom element being configured to receive two or more solar panels, optionally one or more blind panels is/are provided to be replaced by one or more additional solar panel(s).

In a further embodiment, the bottom element comprises an operating space to accommodate operating means of the electric drive means. While such operating means may to some extent be provided in other components, it is preferred to include such means in the bottom element while still allowing appropriate room for the receiving space within the bottom element.

In one advantageous further development of this embodiment, the operating space is located below said receiving space, separated by the upwards facing surface of the bottom element. This provides for a satisfactory compactness and also effectively divides the operating space including the operating means from the screening body accommodated within the receiving space.

In a presently preferred embodiment, the screening arrangement further comprises two side rails configured to be connected to the top casing, preferably to the front rail of the top casing, and to be connected to the side members of the frame so as to extend in the longitudinal direction in the mounted condition of the screening arrangement. Such side rails are useful in many ways; they may provide guidance of the side edges of the screening body and optionally of the bottom element during movement of the screening body in the window opening, transmission means of the operating means of the electric drive means may be positioned in the side rails, and finally, the side rails provide an easy way of preventing the screening body from hanging in the inclined mounted condition of most roof windows, just as a pleasant, picture-frame like appearance is achieved.

In one presently preferred embodiment, the top casing is composed by a set of profiles defining a cross-sectional shape of the top casing, and wherein two end pieces are connected to respective longitudinal ends of the top casing. As for embodiments in which the bottom element is composed by a set of profiles, configuring the top casing may take place in accordance with the type of screening device and improves the flexibility in designing the interaction between the bottom element and the top casing, in particular in the non-screening position.

In one further development of this preferred embodiment, a first profile comprises the front rail, the top cover portion and the back cover portion, and a second profile comprises an additional back element. This configuration is particularly advantageous in case the screening device of the screening arrangement is a roller blind.

In another further development, a first profile comprises the front rail, the top cover portion and the back cover portion, and a second profile comprises fastening means for the top portion of the screening body. This provides for a particularly advantageous configuration in case the screening device is a pleated blind, or other types of blinds in which the screening body is folded-up or collapsed in the non-screening position.

Other presently preferred embodiments and further advantages will be apparent from the subsequent detailed description and drawings.

A feature described in relation to one of the aspects may also be incorporated in the other aspect, and the advantage of the feature is applicable to all aspects in which it is incorporated.

### BRIEF DESCRIPTION OF DRAWINGS

In the following description embodiments of the invention will be described with reference to the drawings, in which

FIG. 1 is a plan view of a screening arrangement in an embodiment of the invention, mounted in a frame of a window;

FIG. 2 is a partial view, on a larger scale, of the upper right-hand corner of the screening arrangement and window of FIG. 1;

FIG. 3 is a partial perspective view of a position indicator mounted on a side rail of the screening arrangement in the embodiment of FIGS. 1 and 2;

FIG. 4 is a perspective view of a screening arrangement in an embodiment of the invention, with the screening body in a screening position;

FIG. 5 is a perspective view of the screening arrangement of FIG. 4, seen from a back side;

FIG. 6 is a partial perspective view, on a larger scale, of a bottom element and a side rail of the screening arrangement of FIG. 5;

FIG. 7 is a partial perspective view, on a larger scale of the bottom element and the other side rail of the screening arrangement of FIG. 5;

FIG. 8 is a partial perspective view of a screening arrangement including an end piece in an embodiment of the invention;

FIG. 9 is a partial side view of a top casing, bottom element, and a side rail of a screening arrangement in an embodiment of the invention;

FIG. 10 is a cross-sectional view of a top casing and a bottom element of a screening arrangement in an embodiment of the invention;

FIG. 11 is a view of the screening arrangement of FIG. 10, in a screening position;

FIG. 12 is a view corresponding to FIG. 10, of another embodiment of the screening arrangement of the invention;

FIG. 13 is a view corresponding to FIG. 10, of a further embodiment of the screening arrangement of the invention;

FIG. 14 is a perspective view of a screening arrangement in an alternative embodiment of the invention;

FIG. 15 is a perspective view of the screening arrangement of FIG. 14, seen from a back side;

FIG. 16 is a partial perspective view, on a larger scale, of a bottom element and a side rail of the screening arrangement of FIG. 15;

FIG. 17 is a partial perspective view, on a larger scale of the bottom element and the other side rail of the screening arrangement of FIG. 15;

FIG. 18 is a cross-sectional view of a top casing and a bottom element of a screening arrangement in an embodiment of the invention, substantially corresponding to the embodiment of FIGS. 14 to 17;

FIG. 19 is a view corresponding to FIG. 18, with a screening body having a different height than in the embodiment of FIG. 18; and

FIG. 20 is a view corresponding to FIG. 18, of an alternative configuration of the bottom element than in the embodiment of FIG. 18.

### DESCRIPTION OF EMBODIMENTS

In the following detailed description, preferred embodiments of the present invention will be described. However, it is to be understood that features of the different embodiments are exchangeable between the embodiments and may be combined in different ways, unless anything else is specifically indicated. It may also be noted that, for the sake of clarity, the dimensions of certain components illustrated in the drawings may differ from the corresponding dimensions in real-life implementations.

It is noted that terms such as “up”, “down”, “left-hand”, “right-hand”, “exterior”, “interior”, “outer”, “inner” are relative and refers to the viewpoint in question.

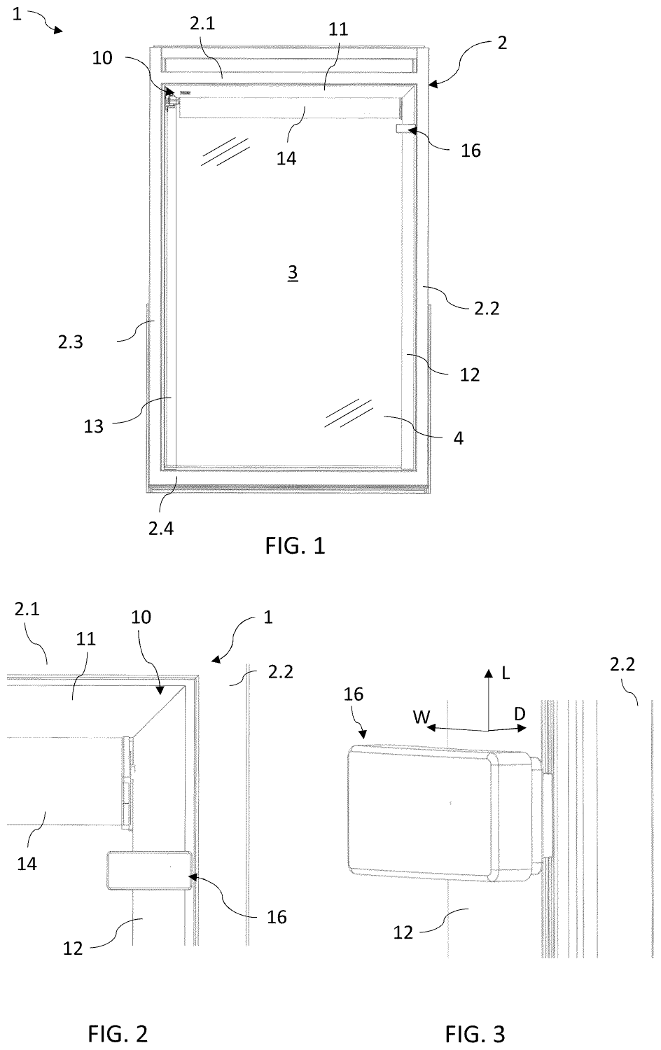

Referring initially to FIGS. 1 to 3, an embodiment of a screening arrangement generally designated 10 is shown, mounted in a frame 2 representing a window. In the shown configuration, the frame 2 constitutes a pane-carrying sash of a roof window 1 and may be pivotable about a centre axis, or top-hung, relative to a stationary frame (not shown) of the roof window 1. The frame 2 may likewise be a stationary frame, which in a mounted position of the window lines an aperture in a building. It is noted that the term “frame” is to be understood as incorporating any substantially rectangular structure positioned in any opening in a building, whether in a wall or the roof, and surrounding an opening 3 to be screened. The screening arrangement 10 may thus be utilised in connection with e.g. windows having a frame only, windows having a sash and a frame, or in doors. In the present context, the screening arrangement 10 will be described as an interior screening arrangement mounted on the interior side of a roof window, i.e., the side facing an inside room of a building, in other words an internal, or an interior, roof window screening arrangement 10.

The frame 2 has a top member 2.1, two mutually parallel side members 2.2, 2.3, and a bottom member 2.4, surrounding the opening 3 to be screened, covered by a suitable panel element such as insulating glazing in the form of a pane 4.

The screening arrangement 10 comprises a screening device including a screening body 15 having two side edges and a top and bottom portion, to be shown and described below. The screening body 15 is typically made from cloth or fabric, which may be flexible to allow rolling up, but may also be pleated, as will be described below in connection with the individual embodiments. However, other screening devices having other kinds of screening bodies are conceivable for use in the screening arrangement of the invention. Hence, it is noted that as used herein the term “screening body” is intended to encompass all feasible types of screening bodies, examples being roller blinds, lamella blinds, curtains, awnings, roller shutters, and shades.

The screening device of the screening arrangement 10 further comprises a top casing 11 located at the top member 2.1 of the frame in the mounted condition of the screening arrangement 10. A top portion of the screening body 15 is typically fastened to a winding, folding, or rotating structure such as a spring-biased roller bar accommodated in the top casing 11, which also accommodates the top portion of the screening body 15.

A bottom element 14 of the screening device of the screening arrangement 10 is connected to a bottom portion of the screening body 15 and configured to be longitudinally positionable in the longitudinal direction L between a non-screening position of the screening body 15 as shown in FIG. 1 and one of a number of screening positions in which the screening body 15 has been deployed, including a fully screening position in which the bottom element 14 is positioned at or near the bottom member 2.4 of the frame 2.

In the non-screening position of the screening body 15, the screening body 15 is configured to assume a rolled-up, folded-up or collapsed condition, at least partly accommodated within the top casing 11 as will be described in further detail below.

In the embodiment shown, two side rails 12, 13 are provided in the screening device, each extending in a longitudinal direction L, perpendicular to a width direction W and a depth direction D as shown in FIG. 3. Referring also to figures of other embodiments described below, each side rail 12 comprises a first flange 121, a second flange 122 and a leg 123. The leg 123 extends at substantially right angles to the first and second flanges 121, 122 and serves to fasten the side rail 12 to the frame 2. In the embodiment shown, an upper end of the side rails 12, 13 is connected to a respective longitudinal end of the top casing 11.

In the embodiments of the invention, the movement of the bottom element 14 and hence of the screening body 15 is provided by means of electric drive means operably connecting the bottom element 14 and the side rails 12, 13 as will be described in some detail below.

Finally, the screening arrangement comprises a position indicator 16 slidably positionable along one or the other of the side rails 12, 13 for manually indicating a desired longitudinal position of the bottom element 14. In the following, the position indicator 16 will be described as being positioned on the right-hand side rail 12. The longitudinal position of said position indicator 16 is manually adjustable by physical movement of the position indicator to an arbitrary longitudinal position along the side rail 12. The bottom element 14 is provided with a notch 141 by which the position indicator 16 is able to be brought into releasable positive engagement.

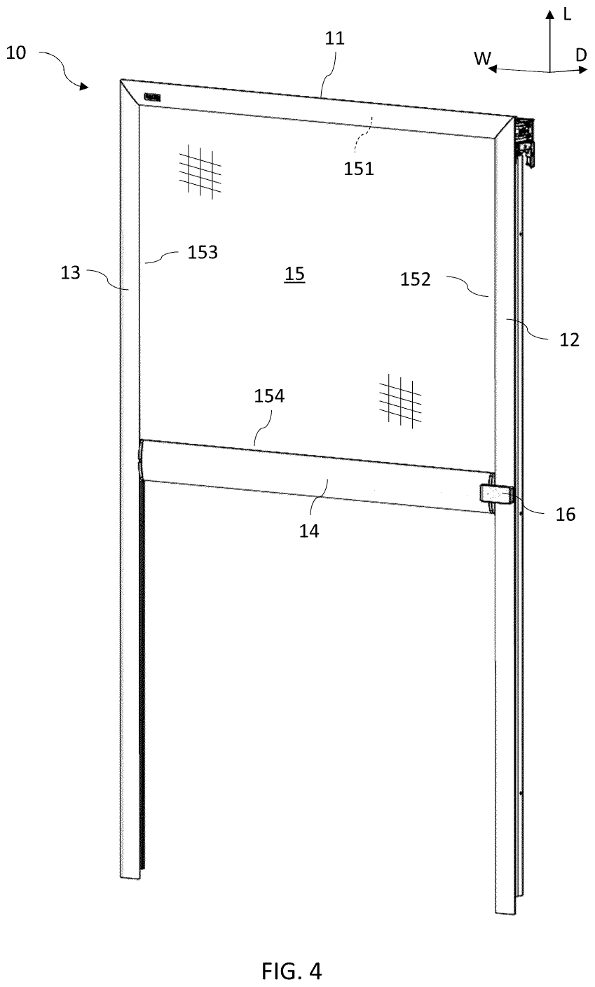

Referring now also to FIGS. 4 to 7, an embodiment is shown in which the screening device of the screening arrangement 10 is a roller blind. The screening arrangement 10 is shown in a front and rear view, respectively, and in a screening position.

The screening body 15 defines a screening plane in the screening position substantially parallel to a plane defined by the longitudinal direction L and the width direction W. Side edges 152, 153, or elements at the side edges, of the screening body 15 and end portions of the bottom element 14 are guided in respective side rails 12, 13.

The general positions of a top portion 151 and a bottom portion 154 of the screening body 15 are indicated in FIG. 4. It is noted that the terms top portion and bottom portion of the screening body 15 denote the position the respective portions assume in a mounted condition of the screening arrangement 10. Other mounting positions are conceivable.

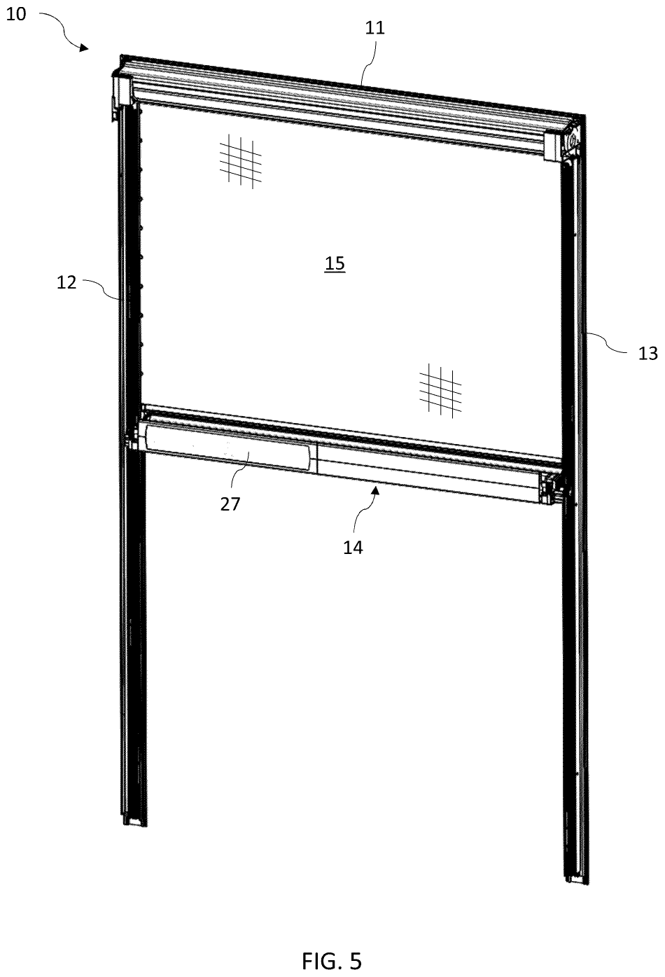

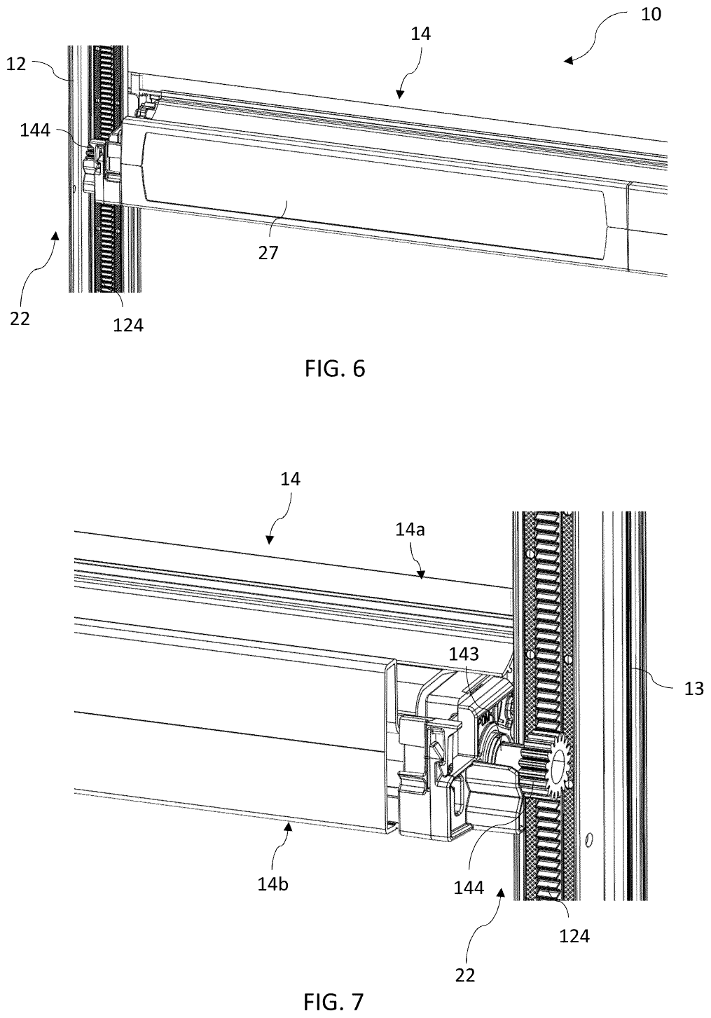

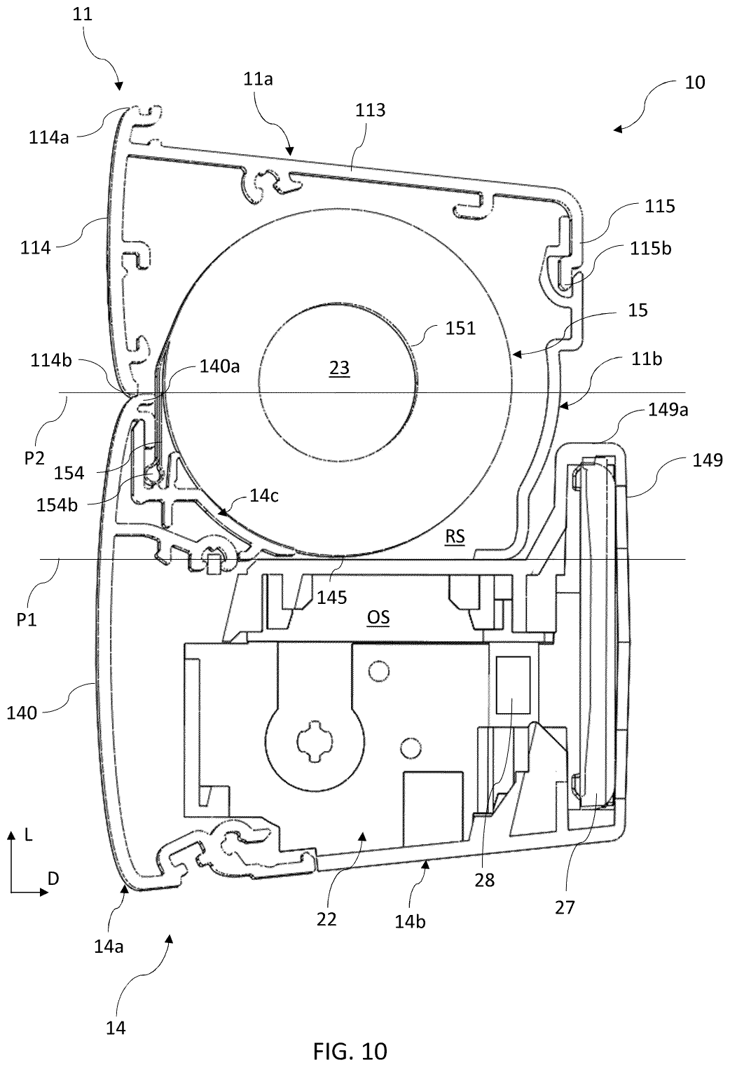

In the embodiments shown, the screening device is electrically operated by means of electric drive means 22 of the screening arrangement 10. In order for the electric drive means to work, energy is required. The energy may be collected from solar panels 27 as shown in FIGS. 5 and 6, possibly also by mains power supply, and optionally supplemented by battery means 28 (shown in FIG. 10). For the solar panels to be able to be exposed to as much sunlight as possible it is preferred to have the solar panels 27 placed on the side of the bottom element 14 facing the window glazing, assuming the screening arrangement 10 is mounted on the inside side of a window. The solar panel generally extends in a plane parallel to the screening plane.

Further details shown in FIGS. 6 and 7 include operating means of the electric drive means 22. The operating means comprise a cogwheel 144 for interacting with a rack 124 on each side rail 12, 13 to translate rotational movement of the cogwheel 144 to translational movement of the bottom element 14. One cogwheel 144 is present at each longitudinal end portion of the bottom element 14, as shown on a rotatable shaft 143, and the cogwheels 144 constitute first transmission means to interact with second transmission means including the two racks 124 arranged in the respective side rails 12, 13 to facilitate the translational movement of the bottom element 14 along the longitudinal direction L. Other drive means are conceivable. Further elements of the operating means of the electric drive means accommodated in the bottom element 14 may include battery means 28 of the embodiment of FIG. 10 and a printed circuit board.

By the term “at each longitudinal end portion” etc. is to be understood throughout the description and claims that the cogwheels are provided at, near, or proximate such end portions of the bottom element. This does not exclude that parts, portions or components of the bottom element may be present beyond the position of the cogwheel, as seen the longitudinal direction of the bottom element, or width direction W of the screening arrangement 10. By near or proximate, it is meant that the cogwheels are disposed or oriented so as to engage a corresponding rack to move the screening body between a screening position or state and a non-screening position or state when such operation is desired, i.e., moving between a screening position or state and a non-screening position or state. Typical ranges for any distance between the cogwheels and the respective physical end portion of the bottom element are 0 to 20 mm, in particular 5 to 10 mm.

By the term “in the side rail” etc. is to be understood that the rack is located in conjunction with, associated with, or on the side rail in question. The rack may be formed as a separate part connected to the side rail, be formed integrally with, or constitute a portion of the side rail.

Depending on whether the screening arrangement is powered solely by solar panels 27, possibly supplemented by battery means 28 as shown in the embodiment of FIG. 10, or also by mains power, end pieces of the top casing 11 interact with suitable mounting brackets (not shown) provided for instance on the side members 2.2, 2.3 of the frame 2. Such mounting brackets are well-known in the art and are typically pre-mounted in commercially available roof windows, comprising a standard version or a version including electric contacts as described in Applicant's European patents Nos. 2002079 and 3203008.

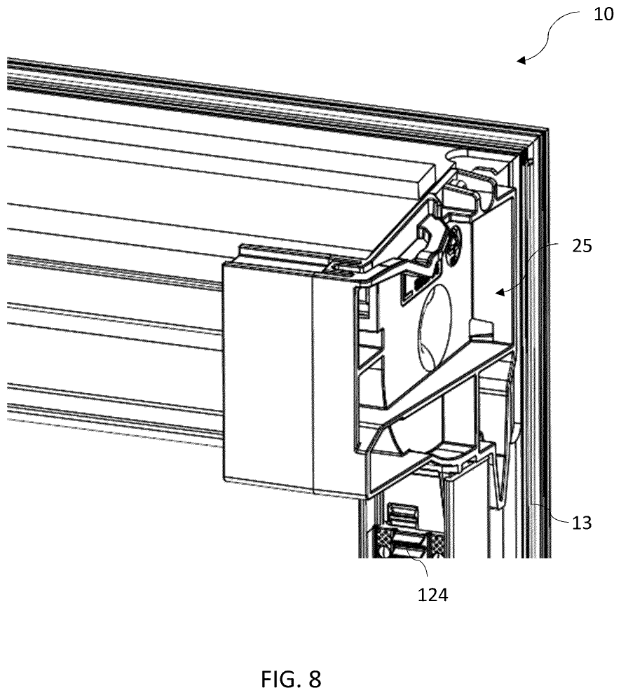

In that regard, the embodiment shown in FIG. 8 provides a detailed rear view of the top casing 11 as shown in FIG. 5, in which an end piece 25 is shown to interact with a standard version mounting bracket. This is made possible, since the solar panels 27, possibly supplemented by battery means, provide the power required to operate the screening arrangement 10.

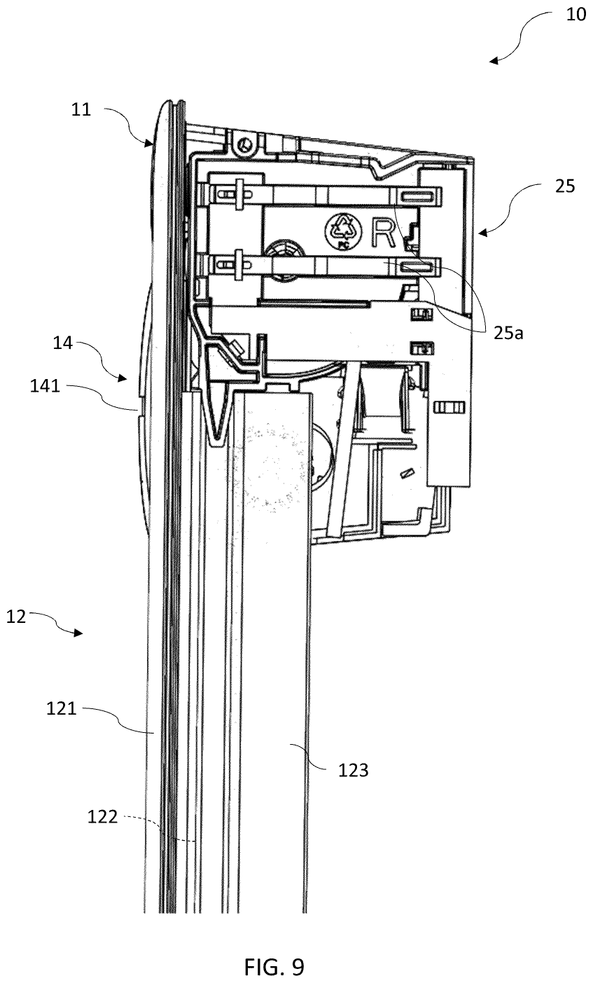

FIG. 9 shows a detailed side view of the top casing 11 of an alternative embodiment in which the end piece 25 is provided with electric terminals 25a for interaction with a mounting bracket including electric contacts, for instance of the kind mentioned in the above.

Regarding the configuration of the top casing 11 and its interaction with the bottom element 14, particular reference is made to FIG. 10.

The top casing 11 has a general configuration well-known from for instance Applicant's WO 2008/131757 A1 and WO 2008/131761 A1. Thus, the top casing 11 comprises a front rail 114 provided as a rail-like element with a surface facing the interior in the mounted condition of the screening arrangement 10. The front rail 114 defines a first direction corresponding to the width direction W of the screening arrangement 10, the first direction being perpendicular to a second direction corresponding to the longitudinal direction L, the first and second direction being perpendicular to a third direction corresponding to the depth direction D. The front rail 114 has a predefined height, i.e. extension in the length direction L, between a top edge 114a and a bottom edge 114b.

In the embodiment shown, in which the screening arrangement 10 is provided with side rails 12, 13, the surface of the front rail 114 facing the interior in the mounted condition of the screening arrangement 10 corresponds in substance to the surface of the side rails 12, 13 and the side rails 12, 13 typically have a dimension in the width direction W in the mounted condition of the screening arrangement 10 corresponding to the height of the front rail 114. The front rail 114 is provided with two mitred ends to cooperate with counterpart mitred ends of the respective side rails 12, 13 to render the screening arrangement 10 with a picture frame-like appearance.

Furthermore, the top casing 11 comprises a top cover portion 113 and a back cover portion 115 with a bottom edge 115b. The top casing 11 and, if present, the side rails 13, 14 are typically made from extruded profiles of an appropriate material such as aluminium or other material including composites. As will be described in more detail below, the top casing 11 is in the embodiment shown composed by a set of profiles 11a, 11b defining a cross-sectional shape of the top casing 11.

The bottom element 14 comprises a front 140 and a back portion 149. An upwards facing surface 145 is present between the front 140 and the back portion 149. The back portion 149 has a top edge 149a and a generally plane extension in the longitudinal direction L. The back portion 149 accommodates the solar panel 27 (cf. FIGS. 5 and 6) on an exterior side, as seen in the mounted condition of the screening arrangement 10.

The term “accommodate the solar panel” is intended to encompass that the solar panel or solar panels are connected to or received within parts or portions of the bottom element or fastened to the exterior side of the back portion by for instance adhesion.

Since the screening device of the embodiment shown comprises a roller blind, the screening body 15 is rolled-up on a rotatable roller assembly represented by a roller shaft 23. The roller assembly may comprise additional roller bars. The top portion 151 of the screening body 154 is fastened to the roller shaft 23 in a suitable manner. In the embodiment shown, the bottom portion 154 of the screening body 15 is connected to the bottom element 14 at or near a top edge 140a of the front 140 of the bottom element 14. In order to provide connection of the screening body 15 and the bottom element 14, the bottom portion 154 is in the embodiment shown folded around a locking wire 154a; the package thus obtained is accommodated in a track in the bottom element 14. Other manners of connection are conceivable, as is well-known in the art.

A receiving space RS for receiving at least a part of the rolled-up screening body 15 in the non-screening position is defined within the bottom element 14. The receiving space RS is delimited in the longitudinal direction L by a first plane P1 substantially parallel with a plane spanned by the width direction W and the depth direction D, and a second plane P2 parallel with the first plane P1 and located at a higher level than the first plane P1.

The first plane P1 is generally defined by a lowest point on the upwards facing surface 145, and the second plane P2 is defined by either the top edge 140a of the front 140 or the top edge 149a of the back portion 149 of the bottom element 14, whichever is located at the highest level as seen in the longitudinal direction L. In the embodiment shown in FIG. 10, the highest level is present at the top edge 140a of the front 140.

The upwards facing surface 145 may as shown comprise a plane central portion but could in principle take any form. As such, the upwards facing surface 145 defines a lower-most point for contributing to the receiving space RS for accommodating the screening body 15.

The upwards facing surface 145 also serves as a reference point, namely in that the top edge 149a of the back portion 149 is located at a higher level than the upwards facing surface 145. In this way, it is possible to provide the solar panel 27 with a maximised height in the longitudinal direction L, while at the same time, the bottom element 14 contributes to the available space for accommodating the screening body 15 in the non-screening position.

In FIG. 10, the bottom element 14 is in a position corresponding to the non-screening position of the screening arrangement 10, as the top edge 140a of the front 140 of the bottom element 14 abuts or is close to the bottom edge 114b of the front rail 114 of the top casing 11. The top portion 151 of the screening body 15 is located to the exterior of the front rail 114, as seen in the depth direction D, and above the bottom edge 114b of the front rail 114, as seen in the longitudinal direction L. In this way, a majority of the rolled-up screening body 15 is accommodated in the combined space of the receiving space RS defined within the bottom element 14 and the top casing 11. As it appears, in the embodiment of FIG. 10, the entire screening body 15 is accommodated in the combined space, about half within the top casing 11 and half within the receiving space RS in the bottom element 14.

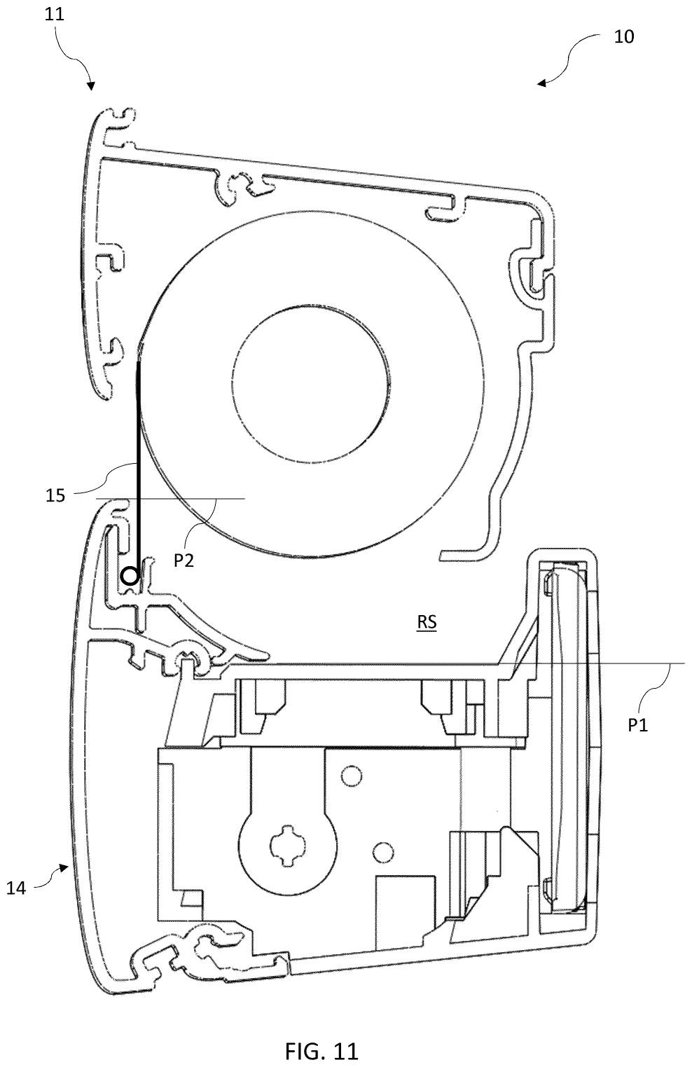

The configuration of the top casing 11 and the bottom element 144 also appears from FIG. 11, in which the bottom element 14 has been moved downwards in the longitudinal direction L to deploy the screening body 15 such that a screening position of the screening arrangement 10 is achieved.

Further details visible in FIGS. 10 and 11 include the configuration of the top casing 11 by the set of profiles 11a, 11b. While the profiles 11a, 11b define the cross-sectional shape of the top casing 11, two end pieces, for instance in the configuration mentioned in the above for the end piece 25 of FIG. 8 or FIG. 9, are connected to respective longitudinal ends of the top casing 11 such that the top casing 11 forms a closed cavity or cassette in which the screening body 15 is at least partly accommodated in the non-screening position. In the embodiment shown, the first profile 11a comprises the front rail 114 as well as the top cover portion 113 and the back cover portion 115. The second profile 11b forms an additional back element adjoining the back cover portion 115 such that there is no access to the roller shaft 23 or rolled-up screening body 15 in the non-screening position. It is noted that the second profile 11b extends below the level of the top edge 149a of the back portion 149 of the bottom element 14. In fact, the lower edge of the second profile 11b is located at the same level as the first plane P1 at the upwards facing surface 145 of the bottom element 14. The profiles 11a, 11b may be extruded and interconnected in any suitable manner.

Correspondingly, in the embodiment shown, the bottom element 14 comprises a main portion composed by a set of profiles 14a, 14b, 14c defining a cross-sectional shape of the bottom element 14, and two end portions located at respective longitudinal ends of the main portion of the bottom element 14. Examples of two such end portions are visible in FIG. 6 and FIG. 7, respectively, but will not be described in detail in the present application. To accommodate such end portions, the first profile 14a has a length exceeding the length of the second profile 14b such that a space is provided at each longitudinal end of the main portion to accommodate parts of the end portions to the exterior of the front 140 comprised in the first profile 14a, as seen in the depth direction D.

In the embodiment of FIGS. 10 and 11, the first profile 14a comprises the front 140 of the bottom element 14 and the second profile 14b comprises the back portion 149 and the upwards facing surface 145 of the bottom element 14, while the third profile 14c is provided for fastening the bottom portion 154 of the screening body 15. The third profile 14c is curved, forming a hollow to accommodate the rolled-up screening body 15 in the non-screening position. The profiles 14a, 14b, 14c may be extruded and interconnected in any suitable manner.

As it also appears from FIG. 10, the bottom element 14 comprises an operating space OS to accommodate operating means of the electric drive means 22, for instance including a motor, drive shafts etc. The operating space OS is here located below the receiving space RS and is separated from the receiving space RS by the upwards facing surface 145 of the bottom element 14. The operating space OS also accommodates the battery means 28.

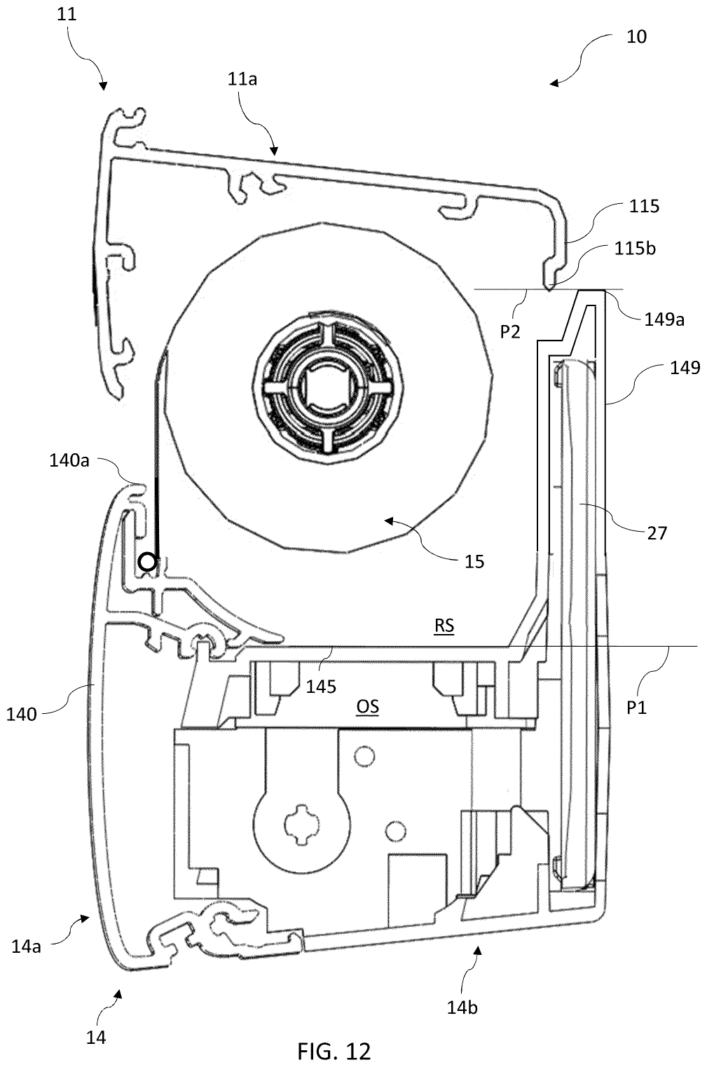

In FIG. 12, another embodiment is shown, in which the top edge 140a of the front 140 of the bottom element 14 is located at a lower level than the top edge 149a of the back portion 149. By this configuration, the back portion 149 is able to accommodate one or more larger solar panels 27 as compared with the embodiment of FIGS. 10 and 11. For instance, each such solar panel 27 may have a height substantially corresponding to the height of the exterior side of the back portion 149 of the bottom element 14.

Specifically, the top edge 149a of the back portion 149 of the bottom element 14 is in this embodiment located at substantially the same level as a bottom edge 115b of the back cover portion 115 of the top casing 11 in the non-screening position.

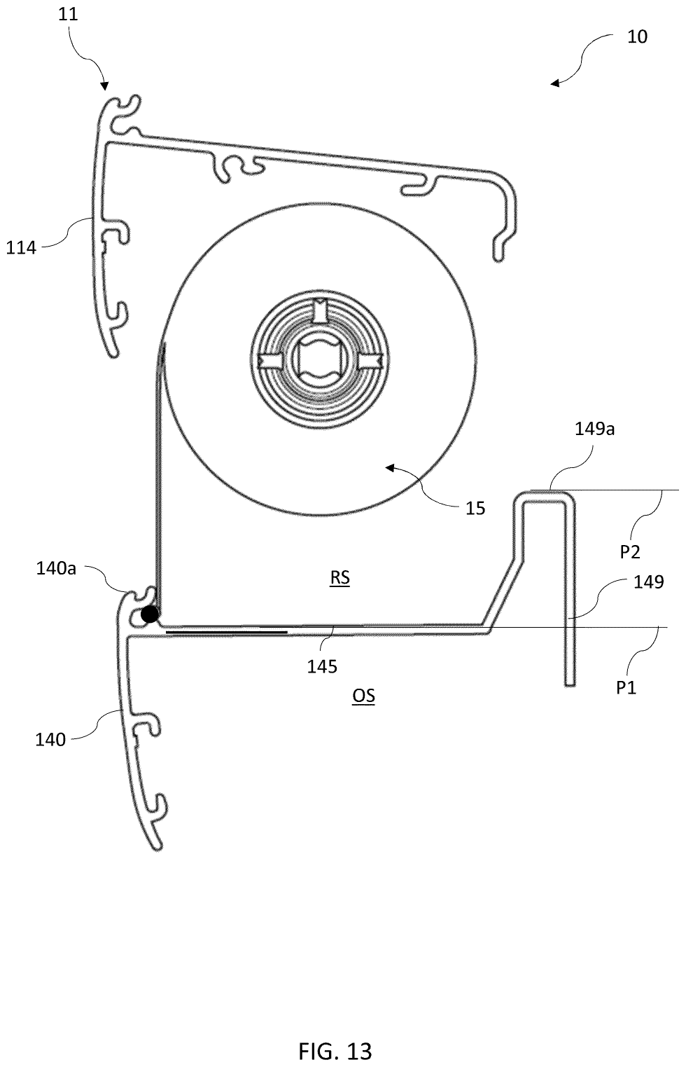

While the upwards facing portion of the bottom element 14 in the embodiments of FIGS. 10-11 and 12 is provided with a substantially U-shaped configuration, the further embodiment of FIG. 13 presents an upwards facing portion which is substantially L-shaped. As indicated, the top edge 140a of the front 140 of the bottom element 14 is located at substantially the same level as the upwards facing surface 145.

A further detail of the embodiment of FIG. 13 is that the front 140 of the bottom element 14 has substantially the same configuration as the front rail 114 of the top casing 11. In this way, it is possible to provide the front rail 114 of the top casing 11, the front 140 of the bottom element 14, and the side rails 12, 13, if present, with substantially the same surface and dimensions, thus rendering a harmonised appearance of the screening arrangement 10 facing the interior, i.e. typically a room in a building. The back portion 149 still has a substantial extension in the height direction to allow for a satisfactory size of the solar panel or panels. The receiving space RS formed by the bottom element 14 may be increased by forming the profile constituting the front 140, the upwards facing surface 145 and the back portion 149 differently, for instance by shifting the upwards facing surface 145 downwards, such that the entire screening body 15 is able to be accommodated within the combined space provided by the top casing 11 and the receiving space RS within the bottom element 14 as is the case in the embodiment of FIGS. 10 and 11.

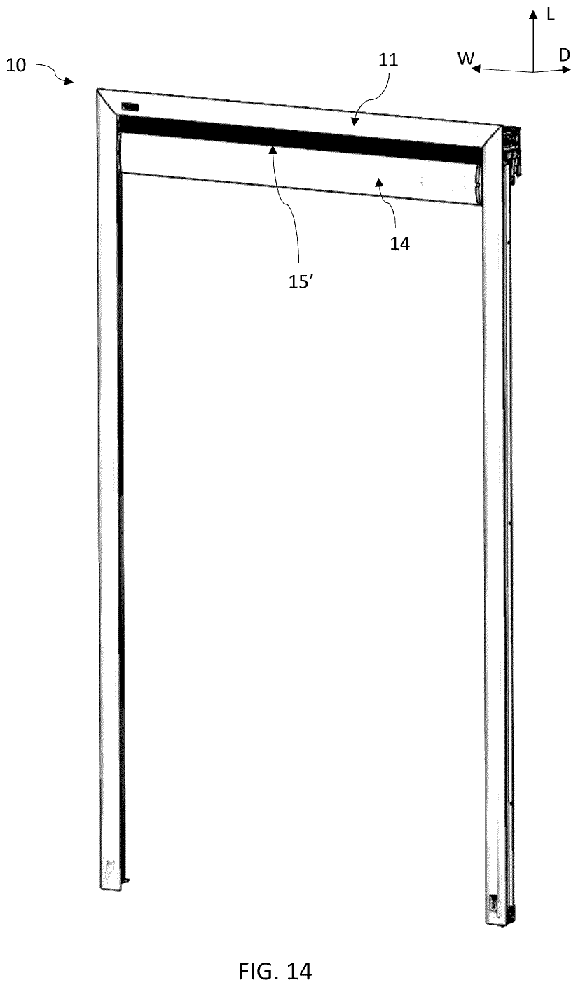

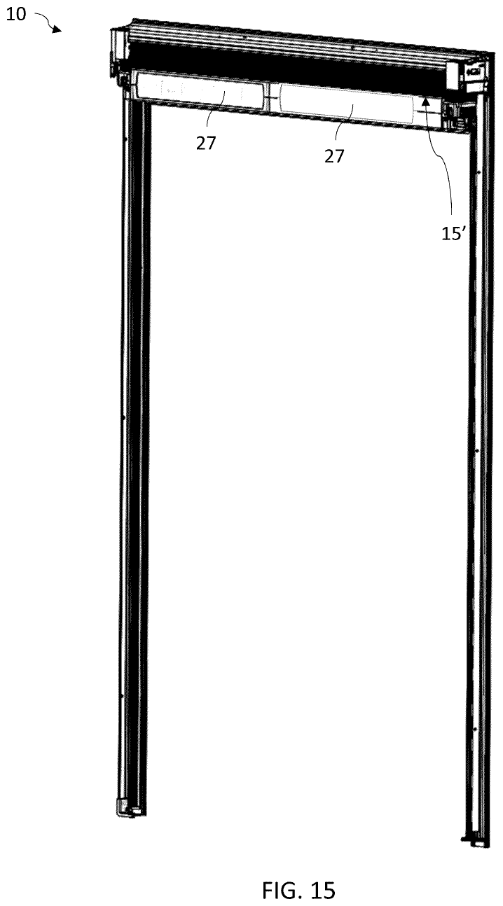

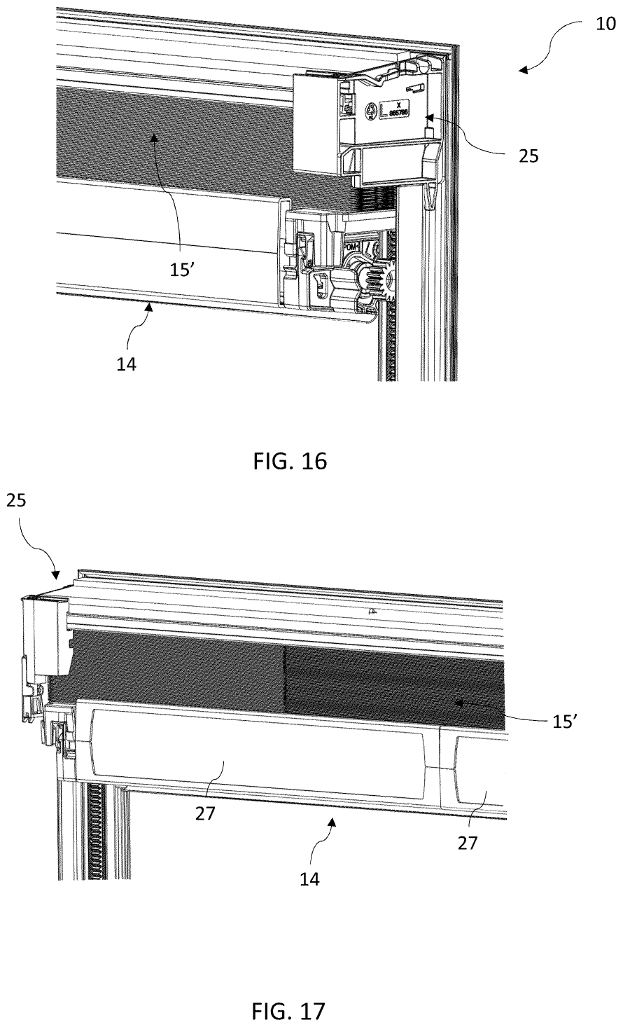

Turning now to FIGS. 14 to 17, an alternative embodiment of a screening arrangement 10 according to the invention is shown. Reference is made also to the description of the above embodiment of FIGS. 4 to 7, and only differences relative to that embodiment will be described in detail. Elements having the same or analogous function are denoted by the same reference numerals to which ‘has been added.

The screening arrangement 10 in this embodiment comprises a screening device in the form of a pleated blind. A screening body 15’ comprises a plurality of pleats which in the non-screening position shown in FIG. 14 are folded-up, or collapsed, into a stack of a certain height in the longitudinal direction L. It is noted that the term “folded-up” will be used throughout the description; however, the term is intended to encompass other types of screening bodies which open and close in an accordion-like fashion.

The height of the stack depends on factors such as thickness of the material of the screening body 15′ and the height of the screening device itself; that is, a taller roof window will require a larger number of pleats in the screening body 15′ for a given material thickness. In the embodiment shown, the screening body 15′ is in fact visible from the interior in the non-screening position as indicated in FIG. 14, different from the screening arrangement 10 of FIG. 4. However, as will be described in further detail below, this is not necessarily the case in all variants of the alternative embodiments.

A further difference appears from FIG. 17, namely that the exterior side of the back portion 149 of the bottom element 14 receives two solar panels 27. Although not shown in detail, further solar panels could be provided. Optionally, the bottom element 14 could accommodate one or more blind panels to be replaced by one or more additional solar panel(s). This configuration is conceivable also to the above embodiments.

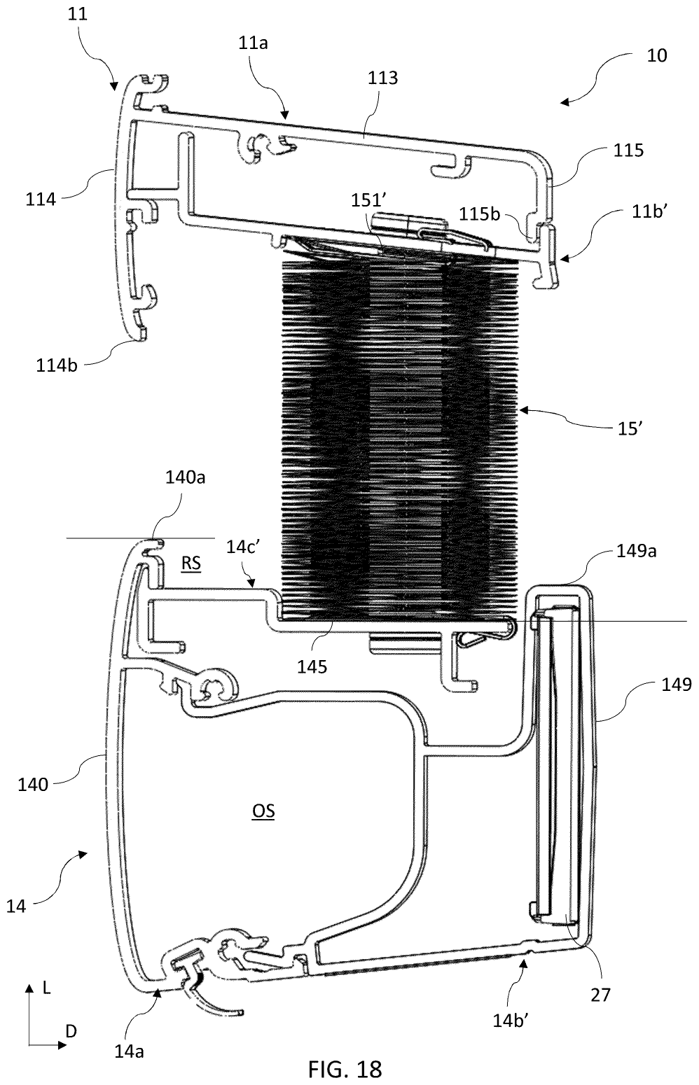

Turning now to FIG. 18, it is seen how the first profile 14a of the bottom element 14 comprises the front 140 of the bottom element 14 as in the embodiment of FIGS. 4 to 7 and as illustrated in FIG. 10. A second profile 14b′ comprises the back portion 149, and a third profile 14c′ comprises the upwards facing surface 145 of the bottom element 14. As it appears, the second profile 14b′ and the third profile 14c′ are configured differently than in the above embodiments. The third profile 14c′ is provided with a stepped portion comprising the upwards facing surface 145 and provided with means for fastening the bottom portion 154′ of the screening body 15′.

Correspondingly, the first profile 11a of the top casing 11 is configured basically as in the above embodiment and comprises the front rail 114, the top cover portion 113 and the back cover portion 115, whereas a second profile 11b comprises fastening means for the top portion 151′ of the screening body 15′.

The combined space for accommodating the folded-up screening body 15′ formed by the top casing 11 and the receiving space RS of the bottom element 14 is in this embodiment of a smaller extent than in the above embodiment as illustrated by a comparison with FIG. 10 such that only just more than half of the stack of folded-up pleats is accommodated in the combined space.

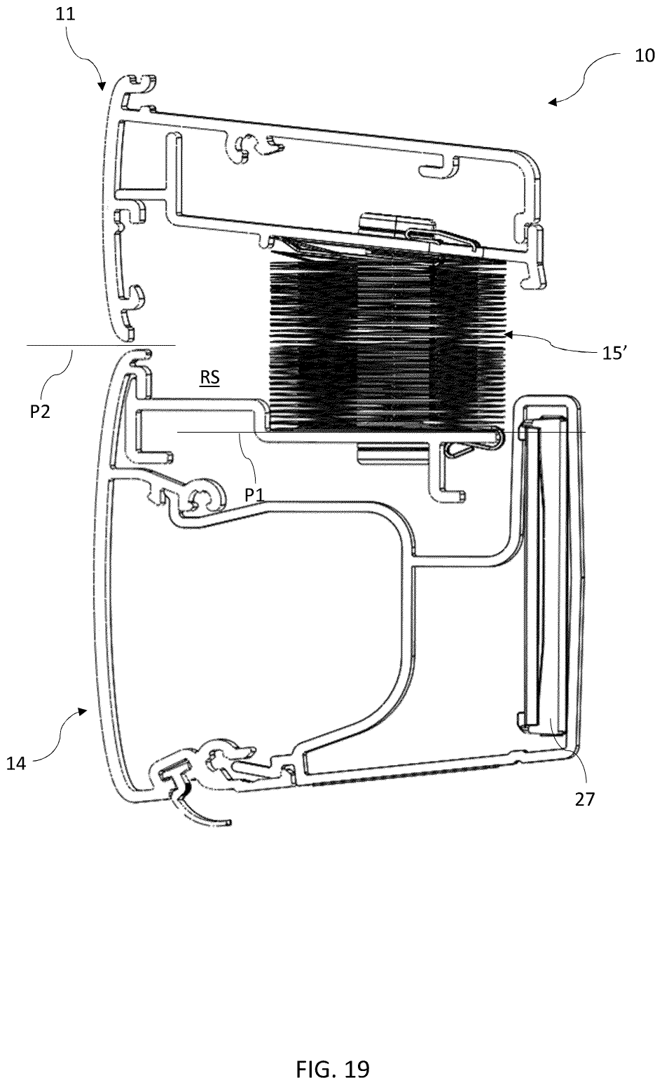

Turning now to FIG. 19 on the other hand, a first variant of the alternative embodiment is shown. Here, the folded-up screening body 15′ is accommodated in its entirety in the combined space of the top casing 11 and the receiving space RS within the bottom element 14. This is made possible by the provision of a thinner cloth of the screening body 15′ and/or a smaller height of the screening body 15′. Typically, manufacture of such pleated blinds takes into account dimensioning the screening body 15′ to the largest size of screening arrangement 10 of a size range, as seen in the longitudinal direction L. In turn, screening arrangements for smaller roof windows thus have over-dimensioned screening bodies, that is, the screening body is normally too long and may thus be shortened without detriment to the functionality.

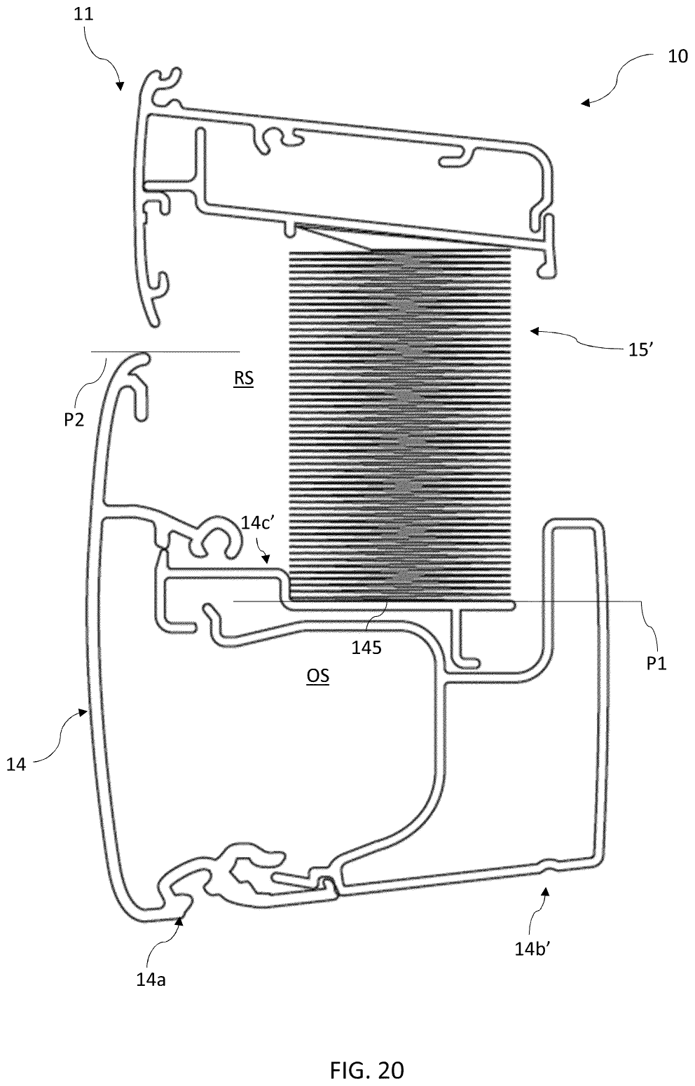

Finally, in FIG. 20 a second variant of the alternative embodiment is shown. The folded-up screening body 15′ is accommodated in its entirety in the combined space of the top casing 11 and the receiving space RS within the bottom element 14 in this variant too. This is made possible by a different configuration of the second profile 14b′ and the third profile 14c′ such that the upwards facing surface 145 is retracted downwards in the longitudinal direction L as compared with the embodiment of FIG. 18.

The following is a list of itemized embodiments:
Embodiment A. A screening arrangement (10) for a window, preferably a roof window (1), said window comprising a frame (2) with a top member (2.1), a bottom member (2.4) and two mutually parallel side members (2.2, 2.3), said screening arrangement (10) comprising:
a screening body (15) having two side edges (152, 153) and a top and bottom portion (151, 154) and configured to assume rolled-up, folded-up or collapsed condition in a non-screening position,
a top casing (11) accommodating at least the top portion of the screening body (15), said top casing (11) comprising
   a front rail (114),
   a top cover portion (113), and
   a back cover portion (115),
the front rail (114) defining a first direction corresponding to a width direction (W) of the screening arrangement, the first direction being perpendicular to a second direction corresponding to a longitudinal direction (L), the first and second direction being perpendicular to a third direction corresponding to a depth direction (D),
a bottom element (14) connected to the bottom portion (154) of the screening body (15) and being configured to be longitudinally positionable in said longitudinal direction (L) by means of electric drive means, between the non-screening position of the screening body (15) and a screening position, in which the screening body (15) has been deployed, the bottom element (14) comprising
   a front (140),
   an upwards facing surface (145), and
   a back portion (149),
the back portion (149) being configured to accommodate one or more solar panels (27) on an exterior side, facing the exterior in a mounted condition of the screening arrangement (10),
wherein the operating means accommodated in an operating space (OS) comprise transmission means operably connecting the bottom element (14) and the side rails (12, 13).

Embodiment B. A screening arrangement (10) according to embodiment A, wherein a suspension assembly is provided at each end of the bottom element (14), each suspension assembly comprising an inner part provided with said first transmission means, and an outer part, the inner part and the outer part being movable relative to each other to allow the cogwheel (144) of the first transmission means to assume an engaged condition in which the cogwheel (144) is in engagement with the rack (124) of the second transmission means and a disengaged condition in which the cogwheel (144) is disengaged from the rack (124), the suspension assembly (40) being configured such that the cogwheel (144) of the first transmission means is allowed to perform a substantially part-circular movement about a centre of rotation located on said screening plane during movement of the inner part relative to the outer part when moving from the engaged condition to the disengaged condition and vice versa.

Embodiment C. A screening arrangement (10) according to any one of embodiments A to B, wherein the electric drive means is powered by solar panels (27) and/or main power, preferably supplemented by battery means. Embodiment D. A screening arrangement according to any one of the preceding itemised embodiments A to C, wherein the screening body (15) defines a screening plane in said screening position substantially parallel to a plane defined by the longitudinal direction (L) and the width direction (W).

Embodiment E. A screening arrangement according to embodiment D, wherein each side edge (152, 153) of the screening body (15) is guided in a track (12b) of the respective side rail (12, 13), and wherein the screening plane substantially coincides with a plane spanned by the tracks.

Embodiment F. A screening arrangement (10) according to any one of the preceding itemised embodiments A to E, wherein the screening arrangement further comprises a position indicator (16) slidably positionable along at least one of the side rails (12) for manually indicating a desired longitudinal position of the bottom element (14), the longitudinal position of said position indicator (16) being manually adjustable by physical movement of the position indicator (16) to an arbitrary longitudinal position along the at least one side rail (12), the position indicator (16) being configured to engage the bottom element (14) by releasable positive engagement means when the bottom element (14) is brought into contact with the position indicator (16) to assume an engaged condition, in such a way that:
i) the positive engagement means is arranged to be released when the longitudinal position of the position indicator (16) is manually adjusted by applying a force on the position indicator substantially in said longitudinal direction (L), and
ii) the positive engagement means is arranged to keep the position indicator (16) in the engaged condition with the bottom element (14) to follow the movement of the bottom element (14) in said longitudinal direction (L) when the bottom element (14) is moved in the longitudinal direction (L) by activation of the electric drive means.

Specific embodiments of the invention have now been described. However, several alternatives are possible, as would be apparent for someone skilled in the art.

Such and other obvious modifications must be considered to be within the scope of the present invention, as it is defined by the appended claims.

### LIST OF REFERENCE NUMERALS

1 roof window
2 frame
2.1 top member
2.2 side member
2.3 side member
2.4 bottom member
3 window opening
4 pane
10 screening arrangement
11 top casing
11a; 11a′ first profile
11b; 11b′ second profile
113 top cover portion
114 front rail
114a top edge of front rail
114b bottom edge of front rail
115 back cover portion
115b bottom edge of back cover portion
12 side rail
12b track
121 first flange
122 second flange
123 leg
124 rack
side rail 13
14 bottom element
14a first profile
14b; 14b′ second profile
14c; 14c′ third profile
140 front of bottom element
140a top edge of front of bottom element
141 notch
143 shaft
144 cogwheel
145 upwards facing surface
149 back portion
149a top edge of back portion
15 screening body
151 top portion
152 side edge
153 side edge
154 bottom portion
154a locking wire
15′ screening body (alternative embodiment)
151′ top portion
154′ bottom portion
16 position indicator
22 electric drive means
23 roller shaft
25 end piece
25a electric terminals
27 solar panel
28 battery means
L longitudinal direction
W width direction
D depth direction
P1 first plane
P2 second plane
RS receiving space
OR operating space

1. A screening arrangement for a window, said window comprising a frame with a top member, a bottom member and two mutually parallel side members, said screening arrangement comprising:
a screening body having two side edges a top portion and a bottom portion and configured to assume a rolled-up condition, a folded-up condition or a collapsed condition in a non-screening position,
a top casing accommodating at least the top portion of the screening body, said top casing comprising
a front rail,
a top cover portion, and
a back cover portion,
the front rail defining a first direction corresponding to a width direction of the screening arrangement, the first direction being perpendicular to a second direction corresponding to a longitudinal direction, the first direction and second direction being perpendicular to a third direction corresponding to a depth direction,
a bottom element connected to the bottom portion of the screening body and being configured to be longitudinally positionable in said longitudinal direction by means of electric drive means, between the non-screening position of the screening body and a screening position, in which the screening body has been deployed, the bottom element comprising
a front,
an upwards facing surface, and
a back portion,
the back portion being configured to accommodate one or more solar panels on an exterior side, facing an exterior in a mounted condition of the screening arrangement,
a top edge of the back portion of the bottom element is located at a higher level than the upwards facing surface,
the bottom element comprises a receiving space for receiving a part of the rolled-up, folded-up or collapsed screening body in the non-screening position, said receiving space being delimited in the longitudinal direction by a first plane substantially parallel with a plane spanned by the width direction and the depth direction, and a second plane parallel with the first plane and located at a higher level than the first plane,
the first plane is defined by a lowest point on the upwards facing surface, and the second plane is defined by a top edge of the front or a top edge of the back portion of the bottom element, whichever is located at the highest level as seen in the longitudinal direction, and
at least the top portion of the screening body is located to an exterior side of and above a bottom edge of the front rail of the top casing such that a majority of the rolled-up, folded-up or collapsed screening body is accommodated in said receiving space and the top casing in the non-screening position.

2. The screening arrangement according to claim 1, wherein the top edge of the front of the bottom element is located at a higher level than the top edge of the back portion.

3. The screening arrangement according to claim 1, wherein the top edge of the front of the bottom element is located at a lower level than the top edge of the back portion.

4. The screening arrangement according to claim 3, wherein the top edge of the front of the bottom element is located at substantially the same level as the upwards facing surface.

5. The screening arrangement according to claim 1, wherein the top edge of the front of the bottom element is located at substantially the same level as the bottom edge of the front rail of the top casing in the non-screening position.

6. The screening arrangement according to claim 1, wherein the top edge of the back portion of the bottom element is located at substantially the same level as a bottom edge of the back cover portion of the top casing in the non-screening position.

7. The screening arrangement according to claim 1, wherein the bottom element comprises a main portion composed by a set of profiles defining a cross-sectional shape of the bottom element, and two end portions located at respective longitudinal ends of the main portion of the bottom element.

8. The screening arrangement according to claim 7, wherein the set of profiles includes a first profile which comprises the front of the bottom element and a second profile which comprises the back portion and the upwards facing surface of the bottom element, and a third profile which is provided for fastening the bottom portion of the screening body.

9. The screening arrangement according to claim 7, wherein the set of profiles includes a first profile which comprises the front of the bottom element and a second profile which comprises the back portion, and a third profile which comprises the upwards facing surface of the bottom element and is provided with means for fastening the bottom portion of the screening body.

10. The screening arrangement according to claim 8, wherein the first profile has a length exceeding the length of the second profile such that a space is provided at each longitudinal end of the main portion to accommodate parts of the two end portions to an exterior side of the front comprised in the first profile, as seen in the depth direction.

11. The screening arrangement according to claim 1, wherein each of the one or more solar panels has a height substantially corresponding to the height of an exterior side of the back portion of the bottom element.

12. The screening arrangement according to claim 1, wherein an exterior side of the back portion of the bottom element is configured to receive two or more solar panels.

13. The screening arrangement according to claim 1, wherein the bottom element comprises an operating space to accommodate operating means of the electric drive means.

14. The screening arrangement according to claim 13, wherein the operating space is located below said receiving space, separated by the upwards facing surface of the bottom element.

15. The screening arrangement according to claim 1, wherein the screening arrangement further comprises two side rails configured to be connected to the top casing and to be connected to the side members of the frame so as to extend in the longitudinal direction in the mounted condition of the screening arrangement.

16. The screening arrangement according to claim 1, wherein the bottom element has a substantially U-shaped or L-shaped configuration.

17. The screening arrangement according to claim 1, wherein the top casing is composed by a set of profiles defining a cross-sectional shape of the top casing, and wherein two end pieces are connected to respective longitudinal ends of the top casing.

18. The screening arrangement according to claim 17, wherein the set of profiles includes a first profile which comprises the front rail, the top cover portion and the back cover portion, and a second profile which comprises an additional back element.

19. The screening arrangement according to claim 17, wherein the set of profiles includes a first profile which comprises the front rail, the top cover portion and the back cover portion, and a second profile which comprises fastening means for the top portion of the screening body.

20. The screening arrangement according to claim 13, wherein an operating means of the electric drive means comprise first transmission means including a cogwheel at each longitudinal end portion of the bottom element and second transmission means including a rack arranged in each of two side rails of the screening arrangement.

21. The screening arrangement according to claim 20, wherein the electric drive means comprise an electric motor located in the bottom element, and wherein the operating means of the electric drive means is accommodated in the bottom element and comprise a rotatable shaft connected with the first transmission means, the bottom element being configured to accommodate battery means and a printed circuit board.
